(19) United States
(12) Patent Application Publication
(10) Pub. No.: US 2012/0062443 A1
(43) Pub. Date: Mar. 15, 2012

(54) ARRANGEMENT FOR DISPLAYING INFORMATION, METHOD FOR DISPLAYING INFORMATION AND ELECTRONIC TERMINAL DEVICE

(76) Inventor: Michael Baldischweiler, Munchen (DE)

(21) Appl. No.: 13/321,010

(22) PCT Filed: May 19, 2010
(86) PCT No.: PCT/EP2010/056887

§ 371 Date: Nov. 17, 2011

(30) Foreign Application Priority Data
May 20, 2009 (DE) 10 2009 022 222.7

(51) Int. Cl. G09G 5/00

(52) U.S. Cl. 345/1.3; 345/1.1

(57) ABSTRACT

The invention relates to an arrangement and a method for displaying information with a first and a second display element, wherein for a user the information of the first display element is visible through the second display element. The invention further relates to an electronic terminal device and a security element for providing trustworthy information.

The invention relates to an arrangement and a method for displaying information with a first and a second display element, an electronic terminal device and a security element for providing trustworthy information.

Electronic terminal devices having optical display element nowadays gain more and more importance in everyday life. In this respect, these terminal devices should meet increasing requirements regarding flexibility, functionality and mobility, so that a user of these devices can carry out almost unrestrictedly a multitude of applications and transactions.

In general, electronic terminal devices for the purposes of this application will be understood to be devices which have a display of information provided by the device. The provision of information also includes the forwarding, looping through, creating, transforming, calculating, and imparting of information. The provision of information is also understood to mean that a display element belonging to the device receives the information in such a way that the provided information is displayed without further treatment, for example recoding, voltage or current level conversion, serial/parallel conversion etc.

As examples of such electronic terminal devices there shall be mentioned telecommunication terminal devices, portable or non-portable computers, personal digital assistants or the like, which by means of different data communication, e.g. via near-field communication connection, with a stationary communication device and/or mobile long-range communication etc., exchange information. Many of the applications or transactions here relate to the processing of confidential or security-relevant information, such as e.g. access codes, personal identification data, one-time passwords, cash values or other business data.

The processing of confidential information mostly is especially secured by the respective portable communication device, but a respective displaying of correspondingly confidential information within the course of the application or transaction on an arrangement for displaying of the electronic terminal device, e.g. a display or the like, often is insecure and thus can be manipulated and/or tampered, since the portable communication devices used mostly are not fully trustworthy terminal devices.

It is therefore desirable, first of all, to make the electronic terminal devices manipulation-proof against attacks and to increase the security of confidential information. For solving this problem, most different approaches have been proposed.

For example, there are known processors for terminal devices, which comprise a trustworthy and an untrustworthy area. The trustworthy area is also referred to as “trusted” or “trust zone”, In such processors, security applications are executed in the trustworthy area, whereas applications which are not security-critical run in the untrustworthy area. A description of these processors is given in the White Paper “TrustZone: Integrated Hardware and Software Security” by T. Alves and D. Felton, July 2004.

Alternatively, for example, from DE 10 2004 014 128 A1 it is known to transmit information, for the purpose of a user's on-site interaction with a stationary service terminal, from the service terminal via a near-field communication connection to the user's portable electronic terminal device and to display this information there on a display element. If, however, the data to be displayed is confidential or security-critical information of the user, the transmission thereof to a portable communication device is connected with significant security risks.

It is therefore object of the present invention to make possible a secure and at the same time flexible display of information of an electronic terminal device.

This object is achieved with the measures described in the independent patent claims. Alternative embodiments or developments of the invention are described in the dependent claims.

The object is achieved according to the main claim by an arrangement for displaying information having a first display element for displaying information provided by an electronic terminal device. The arrangement further has a second display element exclusively for displaying information provided by an autonomous unit. The arrangement here is configured such that the displayed information of the first display element is visible for a user through the second display element.

The arrangement according to the invention makes is possible, in an advantageous way, for a user to assign displayed information, due to different display planes, either to the terminal device or to the autonomous unit. Furthermore, no complex processor structures are necessary and the arrangement does not require more space. In addition, such an arrangement is easy to implement without major hardware or software changes, so that such an arrangement can be realized in a comparatively cost-effective manner.

An autonomous unit for the purposes of this application will be understood to be a unit, an element or a module which is arranged electrically separated from the electronic terminal device. This autonomous unit is also able to provide information.

A display element for the purposes of this application will be understood to be an element which visualizes information in a layer of the element. A display is generally understood to be an apparatus for optically signalling information, data, states and/or values. The display element thus converts electrical information into visual, human-perceptible information.

That the displayed information of the first display element is visible for a user through the second display element is achieved in a first configuration by both display elements being arranged one above the other and the second display element being transparent in the inactive state. This means, that upon a plan view of the arrangement by the user the information of the first display element is visible through the second display element, although the second display element at least partly covers the first display element.

Advantageously, in the arrangement, in a first operating mode the displayed information of the first display element is visible. In a second operating mode the displayed information of the second display element is visible. The arrangement is switchable between the operating modes. In other words, in a first operating mode the first display element is switched to be active and shows the respective information, in a second operating mode the second display element is switched to be active. The switching is carried out or at least initialized in particular by a control unit or the autonomous unit.

Preferably, the autonomous unit provides information which is trustworthy. If this information is displayed exclusively on the second display element, a user can assume that the information is trustworthy. In this respect, this has the advantage that the user characterizes displayed information with regard to the display element and classifies the trustworthiness on the basis of the displaying display element due to the corresponding viewing plane. In particular, the information is trustworthy when it is provided independently of the electronic terminal device.

According to an expedient embodiment, the trustworthy information can be of a visual nature. This information can be a graphic (e.g. a picture) and/or a combination of numbers/letters.

In a preferred embodiment of the invention, the second display element overlaps in the second operating mode the information of the first display element. This is achieved for example by increasing the opacity of the second display element. A second display element transparent in the first operating mode in a simple case is opaque in the second operating mode in such a way that the displayed information of the first display element is not or poorer perceptible/visible for a user.

In an alternative embodiment of the invention, the arrangement has a first display element for displaying information provided by an electronic terminal device, and a second display element exclusively for displaying information provided by an autonomous unit. Here, the second display element is arranged laterally to the first display element and the displayed information of the second display element is coupled into the optical path of the first display element in such a way that this information is visible for a user.

By this alternative embodiment it is possible by means of simple optical coupling apparatuses to direct the information of the second display element in a joint projection direction with the first display element, so that the provided information of the autonomous unit can be displayed. That is, the information of the second display element is coupled into the optical path between first display element and viewer/user of the arrangement.

According to a preferred development of the alternative embodiment, for the coupling a chamfered side of a coupling element is used. The cross-section of the coupling element is preferably triangular, so that the coupling is effected on the entire projection plane of the first display element.

In an alternative embodiment, the top side of the second display element facing away from the first display element is curved. From this curvature there result optical refractions and distortions of the display, so that it is very easily possible for a user to recognize which of the display elements is activated and whether trustworthy information is actually displayed in the second display element. Shape/radius and/or number of the curvature are not restricted here.

In a preferred embodiment, the autonomous unit is a security element. A security element is basically understood to be a hardware component. Information which is provided by this security element is trustworthy for a viewer. I.e., the provided information has been treated, forwarded or received in such a way that a manipulation, tampering or other alteration falsifying the meaning of the information has at least been impeded, and at best prevented. This is achieved for example by means of crypto-algorithms, source codings etc. In a very simple case, the security element can be a “trust zone” of the type described above.

Preferably, the security element is energy self-sufficient from the electronic terminal device. A manipulation of the information displayed in the second display element is thus excluded.

Preferably, the security element receives information via an antenna of a short-range communication device. In a special embodiment, the antenna is arranged in the same plane with the second display element.

The security element preferably is a mass memory card, so that this is incorporated into a terminal device and used for communicating trustworthy or security-relevant information. The mass memory card here has additional ports for an antenna, for receiving security-relevant information via a short-range communication device.

In an advantageous embodiment, the autonomous unit has a display element control unit. Thus, the autonomous unit is completely self-sufficient from the terminal device, so that the information provided is trustworthy.

Furthermore, in this application there is provided a method according to the invention for the secure output of information, having the following procedure steps:
a) providing information of an electronic terminal device for a first display element,
b) displaying the provided information in the first display element,
c) providing trustworthy information exclusively of autonomous unit for a second display element,
d) displaying the trustworthy information in the second display element, wherein for a user the displayed information of the first display element is visible through the second display element, or
e) displaying the trustworthy information in the second display element, wherein for a user the displayed information of the second display element is coupled into the optical path of the first display element.

There is also described an electronic terminal device according to the invention in this application, with an autonomous unit for providing information, a central control unit for providing information as well as an arrangement for displaying this information, wherein the arrangement has a first display element for displaying information provided by the central control unit, has a second display element exclusively for displaying information provided by the autonomous unit, and wherein for a user the displayed information of the first display element is visible through the second display element.

There is finally described a security element according to the invention for providing trustworthy information for an arrangement for displaying information, wherein the arrangement has a first display element for displaying information, has a second display element for displaying information, and the security element has a drive unit for a display element.

In the following, the invention is explained with reference to the Figures. These Figures are not to be regarded to be true to scale. Particularly characteristic elements of the invention may be represented in an exaggerated size and/or in an exaggeratedly simple form for easier understanding. The same components in the Figures have the same reference signs.

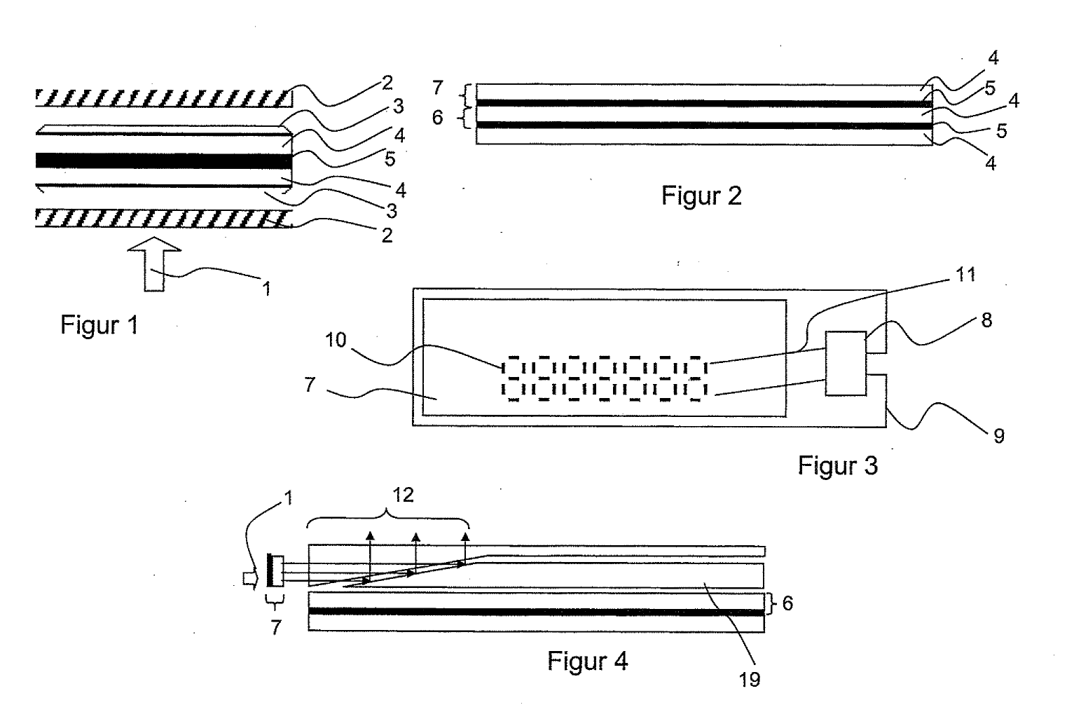

FIG. 1 shows cross-section of an LCD display element according to the prior art

FIG. 2 shows cross section of an arrangement according to the invention for displaying information

FIG. 3 shows plan view of an arrangement for displaying information according to FIG. 2

FIG. 4 shows cross section of an arrangement for displaying information alternative to FIG. 2

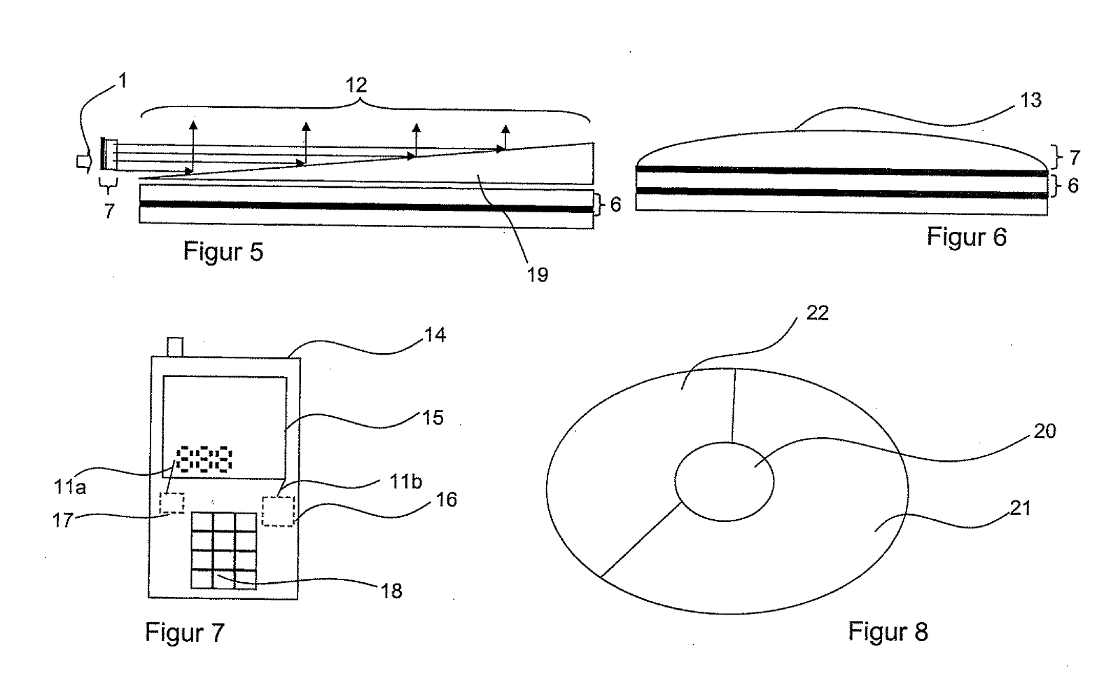

FIG. 5 shows alternative embodiment to the arrangement according to FIG. 4

FIG. 6 shows cross section of an arrangement for displaying information also alternative to FIG. 2

FIG. 7 shows electronic terminal device having integrated arrangement according to FIG. 3

FIG. 8 shows sketch of a processor core structure for providing information

In FIG. 1 there is represented a cross-section of an exemplary display element known from prior art, as it is incorporated in an arrangement according to the invention. In FIG. 1 the display element is an exemplary triple-supertwisted-nematic liquid-crystal cell, also referred to as TSTN-LCD cell. It consists of a lower and an upper polarization layer 2, a lower and an upper filter layer 3, a lower and an upper glass layer 4 and the actual liquid crystal layer 5.

A liquid crystal display element or LCD is a display element whose function is based on the fact that liquid crystals influence the polarization direction of light when a certain amount of electrical voltage U is applied. By means of electrical voltage U the alignment of the liquid crystals in the liquid crystal layer 5 is controlled in each liquid crystal cell of the display element. Thus, the permeability for polarized light, which is produced with a lighting device 1 and polarizing filters 5, is changed. LCDs nowadays are used as display elements in/at many electronic terminal devices, for instance in consumer electronics, measurement devices, mobile phones, digital watches and pocket calculators.

A simple liquid crystal cell is for example a twisted nematic cell, TN cell for short. The liquid crystals used in this cell are organic compounds which have both properties of liquids and properties of solids, for example the birefringence. A simple liquid crystal display element can be realized for example with the Schadt-Helfrich cell (twisted nematic cell, TN cell). Such a cell is not explicitly represented in FIG. 1, however, FIG. 1 contains all the characteristic layers, so that a TN cell can also be explained on the basis of FIG. 1.

The insides of the lower and upper glass layer 4 are covered for example with a transparent electrode layer (indium-tin-oxide layer, ITO), in between there is located the liquid crystal. The electrode layer and the liquid crystals located therebetween in the following are referred to as liquid crystal layer 5. Liquid crystal molecules in the liquid crystal layer 5 order themselves in a given direction, namely parallel to the surfaces of the glass layers 4 which for example are coated with a polyimide and brushed in a preferred direction. The preferred directions of the two glass layers 4 are twisted by 90° to each other. The two glass layers 4 are coated with polarization layers 3 twisted by 90° to each other.

Regarding the functionality of a TN cell: Incident light from the lighting 1 is linearly polarized before entering the liquid crystal layer 5 by means of the lower linear polarization layer 2. From the two glass layers 4 there results a screw-like structure in the liquid crystal, in the case of a screw twisted by 90° one speaks of TN. From the twisting of the molecules there follows a turning of the polarization direction of the light of the lighting device 1, thereby the light being able to pass through the upper polarization layer 2. The TN cell is thus light-transmissive. Since the display is transparent in the resting state, this operating mode is referred to as normally-white mode. If one applies electrical voltage to electrodes of the liquid crystal layer 5, under the influence of the electrical field E there occurs a turning of the liquid crystal molecules. The molecules align themselves parallel to the electrical field E. The twisting of the liquid crystal molecules is thus more and more cancelled, the polarization direction of the light is now no longer turned. The light now can no longer pass through the upper polarization layer 2, the TN cell is impervious to light.

If one orders the lower and upper polarization layer parallel to each other, then the TN cell without voltage U is dark and only becomes transparent with increasing voltage U. This is referred to as the normally-black mode. The Schadt-Helfrich cell thus is (like other liquid crystal displays) a voltage-controlled light valve.

An arrangement for displaying information may consist of any number of such cells (picture elements, pixels). In the case of a pocket calculator, for example, a simple 7-segment display respectively represents one number, in the case of a color-enabled screen, per picture element (pixel) three partial picture elements (sub-pixels) are used for the primary colors red, green and blue.

In the case of STN cells (supertwisted nematic) the twist angle of the molecules is increased to 180 to 270 degrees. In this way there can be achieved a steeper electro-optical characteristic curve and thus an improved multiplex capability compared to TN displays. In the case of DSTN cells, however, there are used two STN layers.

In FIG. 1, there is represented a TSTN cell. The light of the lighting device 1 is polarized by means of the lower polarization layer 2, filtered by means of the lower filter 3, passes through the lower glass layer 4, the liquid crystal layer 5, the upper glass layer 4, the upper filter 3 and the upper polarization layer 2. The color faults of the normal STN technology are compensated by two special foils attached before and behind the cell—between polarizer and glass.

The above descriptions for liquid crystal cells and the corresponding explanations are merely examples of a display element employed in the arrangement. The two display elements can also be produced by means of different technologies. Organic display elements, for example, organ. LED display elements are also conceivable. If in the following there is mentioned a display element, this in principle refers to an element which represents or displays in a first operating state a display of provided information and in a second operating state no display of provided information. In the following Figures, the display element is represented only two-layered, consisting of a liquid crystal layer 5 and at least one glass layer 4. This representation is simplified and, as already indicated, in particular with LCD cells there are to be provided further layers for displaying the information. As a representative for the flexible layer structure there is represented in the following a display element with only one glass layer 4 and one liquid crystal layer 5. The actual structure of the individual display element is not essential to the invention.

It is not essential to the invention, whether it is a reflective, transmissive or transflective display element.

In FIG. 2, there is shown a cross section of an embodiment according to the invention for displaying information. Here, a first display element 6 is represented below a second display element 7. The first display element 6 is electrically conductive connected with a not represented electronic terminal device, the terminal device providing information which is displayed by means of the first display element 6. This first display element 6 corresponds for example to a display of a terminal device.

Above the first display element 6 there is arranged a second display element 7. This second display element 7 displays information which is provided by an autonomous unit. Both display elements 6, 7 form the arrangement according to the invention for displaying information.

If for the second display element 7 there is no information available, this is preferably transparent, so that a viewer can perceive the information of the first display element 6 through the second display element 7.

If information of the autonomous unit is available, this information is also displayed via the second display element 7. In an embodiment of the invention, the first display element 6 is not active in this case, so that exclusively the information of the second display element 7 is visible.

With this arrangement according to FIG. 2, it is now possible to display information via different display elements 6, 7. This has the advantage, that information which should not be provided by the electronic terminal device, can also be displayed. Such information mostly has a security-critical character, or contains at least partly trustworthy information. Referring to the introduction of the description, the display of PINs, OTP, money transfer data, TAN numbers and the like shall be mentioned here. A user viewing this information on the second display element 7 knows, with the help of the arrangement according to the invention, that this information is not provided by the insecure and manipulable electronic terminal device and thus is trustworthy.

In an alternative embodiment, between the first and second display element 6, 7 there is incorporated a background layer (not shown) which effects a visual separation between the first and second display element. Thus, upon displaying the second display element 7, the optical path from the first display element 6 to the viewer is interrupted and only the information of the second display element 7 is displayed.

In a different alternative embodiment, the display of the second display element 7 overlaps the display of the first display element 6. A viewer recognizes, due to the geometric distance between first and second display element 6, 7, on which viewing plane the information is displayed and can decide, in dependence on the viewing plane, whether the information is trustworthy (second display element 7) or not trustworthy (first display element 6).

In FIG. 3 there is shown a plan view of the arrangement represented in FIG. 2. Due to the plan view, now the bottom, i.e. the first display element 6 is not shown. The upper, i.e. second display element 7 has display segments 10 which here are 7-segment displays in a simplified form. The second display element 7, however, is not restricted to 7-segment displays. In addition to FIG. 2, in FIG. 3 there is shown the autonomous unit 8, which by means of control lines 11 is electrically conductive connected with the second display element 7. There is also shown an antenna 9, which is connected with the autonomous unit.

Via this antenna 9 the autonomous unit 8 receives information by means of a near-field communication device, for example integrated in the autonomous unit. The autonomous unit provides this information to the second display element 7. The near-field communication device, NFC for short, is standardized for example according to ISO standard.

In a particularly advantageous embodiment of the arrangement represented in FIG. 3, the antenna 9 is in the same plane as the second display element 7.

In a preferred embodiment, the autonomous unit is energy self-sufficient from the electronic terminal device. This means that the autonomous unit exclusively has its own energy supply and is fully functional while being energetically independent of the terminal device. For example, the energy is effected by means of the electromagnetic field receivable by the antenna 9. Alternatively, the autonomous unit 8 is fed via a battery, accumulator or a capacitor charged by a solar cell. Thus, no electrical connection between autonomous unit 8 and electronic terminal device is needed. Manipulation attacks via an operating system of the electronic terminal device are therefore not possible.

In a not-shown embodiment, information provided by the autonomous unit is received via a contact-type interface device. This interface device exchanges information via serial or parallel communication with the autonomous unit 8. By way of example, a communication via a mass memory card shall be mentioned here.

Preferably, the autonomous unit is a security element which secures the trustworthiness of the information. This includes the calculation of error sums, the provision of digital signatures and the like.

Trustworthy information is assigned, within the context of the application, to secrets selected by a user of an electronic terminal device. This type of information or secret can be a graphic and/or a combination of numbers/letters. Assigning trustworthy information to a secure application is also referred to as personalization. This process can be effected for example by a so-called trusted service. The personalized, secure applications can be deposited via this trusted service in the trusted area 21.

According to the invention, the security element further has a display element control unit. This unit substantially serves to prepare the information to be provided or the electrical signals connected therewith in such a way that the second display element 7 [can—added by the Translator] display the security-critical information without any further or additional hardware components. This means that the display element control unit, which is incorporated in the security element or the autonomous unit, effects all adjustments of the electrical signals. I.e. in the simplest case, the display element control unit is a display controller. In particular, the display element control unit contains devices for level converting, drive devices for the individual picture segments (pixels), serial/parallel data conversion (if required) and the like.

In FIG. 4, there is shown an alternative embodiment to the arrangement represented in FIG. 2. In contrast to FIG. 2, the second display element 7 is arranged laterally to the viewing plane. Via a coupling element 19 and a lighting 1 also laterally arranged, the information provided by the autonomous unit 8 (not shown) can be coupled into the optical path between first display element 6 and viewer. For this purpose, the coupling element has a chamfer 12 according to FIG. 4. If the lighting 7 is activated, i.e. if the lighting sends out electromagnetic radiation, then the available information is displayed by the second display element 7 and directed into the optical path by means of the coupling element 19 indicated by arrows.

FIG. 5 shows a development of the arrangement for displaying information represented in FIG. 4. In contrast to FIG. 4, the chamfer 12 of the coupling element 19 is effected over the entire top side of the coupling element 19. This has, compared to FIG. 4, the substantial advantage that the display of the information provided by the autonomous unit 8 (not shown) is displayed over the entire surface of the arrangement.

In FIG. 6 there is shown an alternative embodiment to the arrangement represented in FIG. 2. Here, the second display element 7 has, on the side facing the viewer, a curvature over the entire top side of the second display element 7. Due to the curvature, especially upon the superposition of the two displays of first and second display element 6, 7, there are produced distortions, which make it possible that the viewer can easier assign the information to one of the display planes. Here, any type of curvature or size of the radius is conceivable. It is not necessary that the curvature is distributed homogeneously over the entire surface, on the contrary it is possible to design the curvature with two or more different radii, or to arrange the curvature only selectively on the top side of the second display element 7.

In FIG. 7 there is represented an electronic terminal device 14 with an embodiment according to the invention for displaying information 15. In this case the electronic terminal device is a mobile communication terminal which can set up a communication by means of mobile phone network. This arrangement 15 has a first (not shown) and a second display element 7. The display segments 10 are connected, as can already be seen from FIG. 3, by means of control lines 11a with a security element 17. This security element 17 has an NFC communication device for receiving security-relevant information which can be displayed on the second display element 7. Via control lines 11b, a central control unit, CPU, is connected with the first display element (not shown). By means of the NFC communication device there can be received, for example, an OTP, a PIN, a TAN or the like via the security element 17. The receipt can also be realized via other wireless communications, for example WLAN, Bluetooth, depending on the configuration of the terminal. The security element detects the receipt of security-relevant information, displays the information in the second display element and switches the first display element to be opaque. A moderate increase of the opacity of the first display element 6 is also conceivable.

Alternatively, the communication can be effected by means of a contact-type interface between the terminal 14 and a security element 17, for example via a mass memory card or the like. As a mass memory card there is mentioned for example an SD card, μSD card, flash memory.

A further possibility for receiving the security-critical information can be realized by means of an NFC interface of an SD card as a security element. Here, the control lines 11a include the contact-type interface between mass memory card and terminal 17. In this embodiment of the invention, a display element control unit is directly integrated either in the mass memory card or in the terminal between the contact-type interface and the second display element 7. It is further conceivable that the mass memory card provides in a first operating mode information for the first display element 6 and the control unit of the terminal, and in a second operating mode information for the second display element 7. A switching between the operating modes is effected either via a separate control unit (not shown) or the memory card itself.

The mass memory card has in particular additional ports for an antenna of a near field communication, so that via an NFC communication information is received from the mass memory card and then made available by the mass memory card as a security element. The mass memory card is preferably provided with a display control unit, so that a driving of the second display element is effected self-sufficiently from further hardware.

In FIG. 8 there is sketched an exemplary structure of a processor. This includes a processor core 20. The superjacent area is divided into a trusted area 21 and a non-trusted area 22. Out of the trusted area 21, there is provided information for the second display element 7. Out of the non-trusted area 22, there is provided information for the first display element 6. The division is substantially effected via software as it is described in the White Paper of the ARM company. Preferably, the trusted area is provided with extra hardware components so as to guarantee a maximum of security for the trustworthy information provided.

A security-critical application can be for example prompting a personal identification (so-called PIN prompt). So as to prevent that for such a PIN prompt there is used a different application out of the non-trusted area 22, the information is displayed exclusively in the second display element 7. This gives the user the assurance that the security-critical or safety-related information has neither been manipulated nor falsified nor tampered.

The representation of the security-critical information assigned to a respective application can at any place of the second display element 7. It can also be provided that the position and/or the type of the display of the information is changed during the execution of an application.

### LIST OF REFERENCE NUMBERS

1 lighting

2 polarization layer

3 filter

4 glass layer

5 liquid crystal layer

6 first display element

7 second display element

8 autonomous unit/security element

9 contactless interface/antenna

10 display segment

11 control lines

12 chamfer

13 curvature

14 electronic terminal device

15 arrangement for displaying information

16 central control unit

17 security element

18 key pad

19 coupling element

20 processor core

21 trusted area

22 non-trusted area

1-20. (canceled)

21. An arrangement for displaying information, comprising:
a first display element that displays information provided by an electronic terminal device,
a second display element that exclusively displays trustworthy information provided by an autonomous unit,
wherein displayed information of the first display element is visible to a viewer through the second display element, and
wherein the information displayed in the second display element is trustworthy to a viewer, because the autonomous unit provides trustworthy information.

22. The arrangement according to claim 21, wherein
in a first operating mode the displayed information of the first display element is visible,
in a second operating mode the displayed information of the second display element is visible and
the arrangement is switchable between the operating modes.

23. The arrangement according to claim 21, wherein the trustworthy information is provided independently of the terminal device.

24. The arrangement according to claim 22, wherein in the second operating mode the second display element overlaps the information of the first display element.

25. The arrangement according to claim 22, wherein in the first operating mode the second display element is transparent.

26. The arrangement according to claim 21, wherein laterally to the viewing plane a lighting device is activatable, thereby making the display of the information in the second display element activatable.

27. An arrangement for displaying information, comprising:
a first display element that displays information provided by an electronic terminal device,
a second display element that exclusively displays information provided by an autonomous unit,
wherein the second display element is arranged laterally of the first display element and the displayed information of the second display element is coupled into the optical path of the first display element in such a way that the displayed information is visible to a viewer.

28. The arrangement according to claim 27, wherein the coupling comprises a chamfered side of a coupling element.

29. The arrangement according to claim 21, wherein a top side of the second display element facing away from the first display element is curved.

30. The arrangement according to claim 21, wherein the autonomous unit is a security element.

31. The arrangement according to claim 30, wherein the security element is energy self-sufficient from the electronic terminal device.

32. The arrangement according to claim 30, wherein the security element is arranged to receive trustworthy information in encoded form via a contactless interface.

33. The arrangement according to claim 32, wherein an antenna of the contactless interface is in a same plane with the second display element.

34. The arrangement according to claim 22, wherein for switching the operating modes a control unit or the autonomous unit is used.

35. The arrangement according to claim 21, wherein the autonomous unit comprises a display element control unit.

36. A method for the secure output of information, comprising the steps:
providing information of an electronic terminal device for a first display element,
displaying the provided information in the first display element,
providing trustworthy information of an autonomous unit exclusively for a second display element,
displaying the trustworthy information in the second display element, wherein for a viewer the displayed information of the first display element is visible through the second display element, or
displaying the trustworthy information in the second display element, wherein for a viewer the displayed information of the second display element is coupled into the optical path of the first display element and wherein the information displayed in the second display element is trustworthy for the viewer, because the autonomous unit provides trustworthy information.

37. An electronic terminal device with:
an autonomous unit for providing information,
a central control unit for providing information,
an arrangement for displaying said information, wherein the arrangement comprises:
a first display element for displaying information provided by the central control unit,
a second display element exclusively displaying trustworthy information provided by the autonomous unit, and
wherein for a viewer the displayed information of the first display element is visible through the second display element, or
wherein the displayed information of the second display element is coupled into the optical path of the first display element, and
the information displayed in the second display element is trustworthy for a viewer, because the autonomous unit provides trustworthy information.
